(19) United States
(12) Patent Application Publication
(10) Pub. No.: US 2018/0293593 A1
(43) Pub. Date: Oct. 11, 2018

(54) CAMERA BASED LOCATION COMMISSIONING OF ELECTRONIC SHELF LABELS

(71) Applicant: PHILIPS LIGHTING HOLDING B.V., EINDHOVEN (NL)

(72) Inventors: FREDERIK JAN DE BRUIJN, EINDHOVEN (NL); STEFAN MARCUS VERBRUGH, EINDHOVEN (NL)

(21) Appl. No.: 15/765,284

(22) PCT Filed: Sep. 19, 2016
(86) PCT No.: PCT/EP2016/072113

§ 371 Date: Apr. 2, 2018

(30) Foreign Application Priority Data
Oct. 2, 2015 (EP) 15188243.8

(51) Int. Cl. G06Q 30/02; G06Q 10/08; G06Q 30/06; G06K 9/20; H04B 10/116; H04B 10/54

(52) U.S. Cl. CPC G06Q 30/02; G06Q 10/08; G06Q 30/06; G09G 2380/04; H04B 10/116; H04B 10/54; G06K 9/2036

(57) ABSTRACT

The present invention relates to a system for commissioning an electronic shelf label (ESL) position using a commissioning device, a commissioning device for use in commissioning an ESL, a method for commissioning an ESL position using a commissioning device and a system backend position, a method for commissioning an ESL position using a commissioning device and a corresponding computer program product, wherein the commissioning device is arranged to acquire a first set of images comprising an ESL and extract an ESL identifier from the first set of images and a relative position of the ESL relative to the commissioning device, to acquire a second set of images comprising a luminaire emitting coded light, extract a relative position of the luminaire relative to the commissioning device from the second set of images, and to transmit the ESL identifier and the position information to the system back-end, the position information based on: the relative position of the ESL relative to the commissioning device and the relative position of the luminaire relative to the commissioning device in order to enable the association of the ESL identifier with the position of the ESL.

### FIELD OF THE INVENTION

The present invention relates to a system for commissioning an ESL position using a commissioning device, a commissioning device for use in commissioning an ESL, a method for commissioning an ESL position using a commissioning device and a system backend position, a method for commissioning an ESL position using a commissioning device and a corresponding computer program product.

### BACKGROUND OF THE INVENTION

In grocery stores, pharmacies, convenience stores and/or warehouses there is a need for providing labels in the vicinity of nearby stored products. In the case of stores such labels may convey information to visitors of the stores, e.g. price information and or further descriptive information. When used in warehousing such labels could be used to inform personnel about which particular part is and/or should be stored on a shelf.

In the past paper labels have been used considerably and are still in use today, although low-cost from a material point of view, management and maintenance involved with paper labels renders such labels less attractive.

To address this issue electronic shelf labels (ESL) have been devised which have a similar informational function; i.e. providing product information such as the product price, but that can be programmed electronically and preferably are centrally managed. Provided that such ESL are properly commissioned; i.e. linked to products, the use of centrally managed ESL furthermore allows product pricing to be updated so that the price that the customer sees on the shelf corresponds to the price at checkout.

Notably although throughout the text ESL is used to designate the electronic labels; such labels need not be particular to shelves only; but could also be used to label other storage spaces and/or containers.

Accurate commissioning of ESL systems to a great extent determines the value of an ESL system; a poorly commissioned system does not represent a significant advance over the conventional paper label system.

A further improvement on ESL management is disclosed in US2011/0035461 A1 which discloses a number of methods for commissioning ESL systems; this prior art system discloses a system for commissioning ESL systems wherein a commissioner collects an ESL identifier (ID), a product ID which are used to create a record linking the ESL ID and the product ID. Based thereon the system retrieves product information for display on the label and then uses the position information to activate the transceiver to communicate the product information to the ESL.

### SUMMARY OF THE INVENTION

Although the prior art system address the updating of ESLs in an ESL system, there is room for improvement; more particularly it is an insight of the inventors that by obtaining more accurate position information and linking the position information with the ESL DD and the product ID further applications are enabled.

In accordance with a first aspect of the invention, the invention provides a system for commissioning an ESL position using a commissioning device, the system comprising a commissioning device and a system back-end. Wherein the commissioning device comprises a first camera for acquiring images relative to the commissioning device, a display for providing visual feedback to a commissioner, a wireless transmitter for transmitting an ESL ID and position information from the commissioning device to a processor, and a processing device arranged to process the images. Wherein the commissioning device is arranged to: acquire a first set of images comprising an ESL and extract an ESL ID from the first set of images and a relative position of the ESL relative to the commissioning device, acquire a second set of images comprising a luminaire emitting coded light, extract a relative position of the luminaire relative to the commissioning device from the second set of images, transmit the ESL ID and the position information to the system back-end, the position information based on: the relative position of the ESL relative to the commissioning device and the relative position of the luminaire relative to the commissioning device in order to enable the association of the ESL ID with the position of the ESL. The system back-end comprising a wireless receiver for receiving the ESL ID and the position information and a processing and storage device for associating the ESL ID and the position information and storing this association.

The term relative position herein is understood to comprise both the relative three dimensional position and three-dimensional orientation, but has been so abbreviated for the sake of conciseness.

The commissioning device in the above manner enables the registration of the position of the ESL and the position of the luminaire relative to the commissioning device. As the position of the luminaire is know from a coded light positioning/localization system, the claimed invention enables the association of the ESL ID in a more elegant manner than prior art systems. Moreover by storing this association in the back-end system, the position of the ESL may be used for providing location based services to shop visitors. In this manner the invention enables e.g. shoppers to be able to locate the nachos and guacamole using an in-shop location service.

Note that the image sets comprise one or more images. For certain methods of encoding in particular when spatial encoding is used; it may be sufficient to have a single image. In the event temporal modulations are employed as is generally the case in coded light, it may be possible to detect the relevant coded light data using a single image detected with a rolling shutter camera. Whether a single image is sufficient depends on the camera (frame rate), modulation and message length. If a single image is insufficient than multiple images in combination with a suitable modulation may be chosen.

Preferably, the position information comprises the ESL position. As certain venues and/or shops already have a coded light based indoor positioning system in place, such a system and mobile terminals used therein may be used as commissioning devices for the system. Such mobile terminals may use the relative position of the ESL and luminaires to determine the ESL position and share the ESL position with the back-end system.

More preferably the ESL position comprises a longitude and latitude of the ESL. By providing a longitude and latitude the ESP position can be exchanged and used by other location services.

Preferably the first set of images and the second set of images are acquired by the first camera by either first acquiring the first images and then acquiring the second images or first acquiring the second images and then acquiring the first images.

In this manner a single camera may suffice, and the display on the commissioning device may be used to provide the commissioner with clear instructions as to what needs to be imaged next.

More preferably the commissioning device further comprises: motion tracking devices comprising a gyroscope, an accelerometer and a magnetometer. And the position information is based on the output of the motion tracking devices over the period in between the acquisition of the first set of images and the second set of images.

In the above manner it is possible to maintain continuity and tie the relative positions to one another, thereby enabling accurate positioning of the ESL.

Preferably the first set of images and the second set of images are acquired during an overlapping time window. In this manner the relative positions are tied together by the very acquisition of the images rendering the use of the motion tracking devices for this purpose obsolete.

More preferably the commissioning device comprises a second camera; the first and second camera directed in opposing directions, and wherein the first camera acquires the first set of images and the second camera acquires the second set of images.

In this manner it is possible to simultaneously, or near simultaneously register both relative positions and continue to provide the commissioner feedback; in particular when the user facing camera is used for determining the luminaire position and the front facing camera on the commissioning device (facing away from the user) is used to image the ESL ID.

Preferably the ESL label ID is extracted from at least one of: image information corresponding to a spatially modulated pattern in the first set of images and image information corresponding to a temporally modulated pattern in the second set of images.

In accordance with a second aspect of the invention, the invention provides a commissioning device for use in commissioning an ESL position, the commissioning device comprising: a first camera for acquiring images relative to the commissioning device, a display for providing visual feedback to a commissioner, a wireless transmitter for transmitting an ESL ID and position information from the commissioning device to a system back-end, and a processing device, wherein the processing device is arranged to process the images and wherein the commissioning device is arranged to acquire a first set of images comprising an ESL and extract an ESL ID from the first set of images and a relative position of the ESL relative to the commissioning device acquire a second set of images comprising a luminaire emitting coded light, extract a relative position of the luminaire relative to the commissioning device from the second set of images, transmit the ESL ID and the position information to the system back-end, the position information based on: the relative position of the ESL relative to the commissioning device and the relative position of the luminaire relative to the commissioning device in order to enable the association of the ESL ID with the position of the ESL.

Preferably the commissioning device is further provided with optical elements that allow imaging of both the first and second set of images simultaneously; e.g. by applying a wide angle lens or prisms (or equivalent thereof), to the existing camera configuration of a mobile.

In accordance with a third aspect of the invention, the invention provides a method for commissioning an ESL position using a commissioning device and a system backend, wherein the method comprises: acquiring a first set of images comprising an ESL, extracting an ESL ID from the first set of images and a relative position of the ESL relative to the commissioning device, acquiring a second set of images comprising a luminaire emitting coded light, extracting a relative position of the luminaire relative to the commissioning device from the second set of images, transmitting the ESL ID and the position information to the system back-end, the position information based on: the relative position of the ESL relative to the commissioning device and the relative position of the luminaire relative to the commissioning device, receiving the ESL ID and the position information by the system back-end and storing the association of the ESL ID and the position information.

Note that extracting in the above corresponds to deriving the data from the images, by computing them based on the fact that the images acquired represent projections of the three-dimensional world, allowing the reconstruction of the relative position based on goniometric transformations.

In accordance with a fourth aspect of the invention, the invention provides a method for commissioning an ESL position using a commissioning device, wherein the method comprises: acquiring a first set of images comprising an ESL, extracting an ESL ID from the first set of images and a relative position of the ESL relative to the commissioning device, acquiring a second set of images comprising a luminaire emitting coded light, extracting a relative position of the luminaire relative to the commissioning device from the second set of images, transmitting the ESL ID and the position information to a system back-end, the position information based on: the relative position of the ESL relative to the commissioning device and the relative position of the luminaire relative to the commissioning device.

In accordance with a fifth aspect of the invention, the invention provides computer program product characterized in that it comprises program code instructions for implementing a method as indicated above. The computer program product may correspond to a downloadable file or a computer readable medium such as an optical data carrier, or other non-volatile storage device such as a memory stick or Flash memory.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1, shows an example of a luminaire for use in the coded light based indoor positioning system,

FIG. 2, depicts a preferred embodiment of the invention for associating an ESL ID with a position based on coded light detection,

FIG. 3, depicts a preferred embodiment wherein the front and user facing cameras of a smart phone are used for associating an ESL ID with a position, and

FIG. 4, depicts a side view of an ESL component with an optical element.

In the Figures, elements which correspond to elements already described may have the same references.

### LIST OF REFERENCE NUMERALS IN FIGURES

100 luminaire
105 data
110 receiver
115 modulation data
120 driver/modulator
125 light source
130 illumination light with modulated light component
200 system
205 localization system controller
210 data combiner
220 ESL system controller
230 database linking luminaire ID to luminaire location and reverse
240 database linking ESL location to ESL ID and reverse and linking product location to product identifier and reverse
250 database linking ESL identifier to product ID and reverse
305 outline of the luminaire in the luminaire plane (generally horizontal)
310 luminaire coordinate system
315 project front camera frame
320 electronic shelf label
325 label specific identity pattern
330 shop coordinate system
335 device coordinate system
340 mobile device
345 label coordinate system
350 projected back camera frame
405 ESL housing
410 ESL display
415 optical output element
420 optical input element
431 clamping member 1
432 clamping member 2

### DETAILED DESCRIPTION OF EMBODIMENTS

Electronic shelf labels (ESLs) offer retailers the ability to wirelessly update content on shelving and/or signage without the need to print paper tags or to deploy multiple employees to change them manually. ESLs also offers retailers the ability to update pricing as often as they want (dynamic pricing).

A wide variety of low-power display technologies are being employed in conjunction with ESLs. Typically these include liquid crystal display (LCD) technology and electrophoretic display technology also known as electronic paper or e-ink displays.

ESL providers generally use a wireless connection, generally based on radio transmission, or infra-red to communicate with the ESLs from some central ESL control system.

### Label Localization

In some cases, the wireless connection is also used to locate the ESLs within the shop. Such localization always requires that the ESL connects to multiple transceivers of the central ESL control system.

Current wireless localization methods generally use transmitters and receivers that are (almost) omnidirectional. This means that both transmitter has no control over the transmission direction and the receiver is agnostic of the precise reception angle. As a consequence, localization of an ESL between multiple transceivers is generally based on the relative signal amplitudes. Alternatively, the relative time delays of signals could be used. In a practical situation, however, where a shop is filled with metal shelves and occupied with a shopping crowd, where the path between ESLs and central transceivers can be occluded and where the signals can be subject to multiple reflections, the accuracy of ESL localization based on the wireless signals is known to drop significantly.

The inventors aim to leverage the “electronic” localization of ESLs, eventually as a basis for product localization and possibly other location based services.

Although electronic ESL localization already exists, it suffers from various shortcomings.

### Device Localization

Alongside with the worldwide embrace of smartphones, various solutions for indoor localization are emerging. Exploiting the smartphone's rich communication and sensing capabilities, the range of technologies for indoor localization seems endless. Yet to this time, only two technologies seem to perform adequately in practical indoor environments: radio and coded light.

A quickly emerging radio technology is Bluetooth low energy (BLE), which outperforms Wi-Fi in terms of localization accuracy. BLE is primarily intended for localization on the basis of proximity, using a unique BLE beacon for each location of interest. However, attempts to improve localization accuracy (e.g. using weighted interpolation based on signal strength) fails in the practical situation of actual grocery stores or warehouses for the abovementioned reasons.

Instead the present invention aims to leverage the capabilities of code light. Coded light here is used as a term to refer to illumination light that has modulated thereon information. Coded light is therefore different from e.g. infra-red communication per se as coded light has a dual function; it serves an illumination purpose and it serves a communication purpose. As both functions tend to be substantially simultaneous (data transfer need off course not be continuous), the modulation used for modulating the illumination light is chosen such that the modulation for data transmission is substantially invisible to the human eye.

An example of a coded light based navigation system is e.g. the system disclosed in U.S. Pat. No. 6,807,478 hereby incorporated by reference.

When such a coded light system is used for localization purposes the information conveyed using the lighting infrastructure may range from simple luminaire identifiers to location coordinates comparable with those one would may derive from a GPS signal. The advantage of using coded light over RF technology is that as a result of the line-of-sight requirement (products need to be illuminated in shops using the lighting infrastructure), there generally is significantly less occlusion than then using other technologies.

Coded light detection is possible both with global-shutter cameras, see e.g. the system disclosed in U.S. Pat. No. 8,755,561, hereby incorporated by reference, as well as with rolling-shutter cameras as published international patent applications WO 2012/127439 or WO2014/037866 both hereby incorporated by reference, the last of which are commonly used in mobile devices.

The use of the camera for coded light detection comes with the opportunity to use the appearance (i.e. location, orientation and perspective distortion) of the luminaires in the image frame as a basis for precise device localization. Therefore, the luminaire IDs extracted from the coded light are used to lookup their location and orientation within the indoor space. Particularly, in combination with the motion sensor data to recover the device orientation, the location of the device can be estimated with an accuracy down to a few centimeters as published in international patent application WO2015/144553 hereby incorporated by reference.

Various providers of ESL systems provide device localization and related location-based services as additional function to their ESL system. Most are based on the use of BLE beacons, but as indicated in the above discussion on label localization, for interpolated device localization BLE fails to offer sufficient accuracy.

The accuracy of indoor localization on the basis of the generally omnidirectional transmission and reception of wireless data communication methods tends to deteriorate in the practical situation of a shopping environment. This affects the accuracy of radio based device localization and particularly affects the accuracy of label localization, since the labels tend to be mounted directly on metal shelfs.

It is an aim of the invention to overcome the shortcomings of existing localization technologies by providing accurate electronic shelf label localization both in the horizontal plane as well as in the third spatial dimension, such that at the same lateral position, the localization system can differentiate between shelf labels at different heights.

Since ESLs are coupled to products on a one-to-one basis, the location of the ESL is close to the location of the product. Creating and keeping up to date a product location database of a store is a lot of work and is prone to errors. On the other hand, a reliable product location database is very valuable for retailers (for example to provide product finding through VLC to shoppers).

The invention is based on the known ability to use the smartphone camera to detect coded light and to use the smartphone's processing and communication capabilities to interpret coded light, with the aim to use the lighting system as a reference for estimating the 3D location of the camera device down to centimeter accuracy.

The invention is also based on the known ability of smartphones to interpret alphanumerical text from captured imagery as well as the ability to decode barcodes, QR-codes, ARTags and other machine readable codes and/or patterns from captured imagery.

In various embodiments, it is assumed that each ESL is capable of displaying its own unique identifier, the ESL ID, e.g. after receiving a wirelessly broadcasted command to do so. The ESL ID could for instance be displayed as alphanumerical text or as a standardized identity pattern.

Alternatively if the ESL is provided with an illumination device; such as a LED then this LED may be used to emit the ESL ID using a simple low-cost red LED by modulating its light output. Although according to the strict definition above such modulated emission would not qualify as coded light per se; as it does not have an illumination function a similar modulation may be used as that for the illumination light. As a result it would be possible to re-use the software used for detecting the coded light from the illumination lighting to also capture the ESL-ID as modulated in the LED output.

Preferably such an LED device on the ESL would comprise an optic, such as a lens or a diffuser that protrudes slightly from the flush surface of the ESL. As a result it is easier for a commissioner to image the LED device on the ESL as it is less directionally sensitive.

Furthermore, preferred embodiments of the system are based on the combined use of the two cameras of a smartphone or tablet computer. Such combined camera use involves a first camera capturing coded light and a second camera captures an identifier on the ESL.

As the user captures the barcode of the ESL with the back-facing camera, the front-facing camera captures the coded light from the ceiling luminaires. FIG. 3 illustrates such use of both cameras in a typical usage situation.

Similar to using the expected appearance of the luminaires in position estimation as disclosed in WO2015/144553, the expected appearance of the ESL can be used to estimate the location of the capturing camera with respect to the ESL.

A further preferred embodiment of the invention comprises an electronic device, typically a smartphone equipped with a front and back camera. It also comprises a lighting system with encoded luminaires, each of which imperceptibly transmitting a unique identifier within the emitted light. It also comprises an electronic shelf labelling system with addressable electronic shelf labels (ESLs), each of which holds a unique ESL identifier.

The drawing in FIG. 2 depicts a preferred embodiment of the invention in the application of building a table of product locations based on a predetermined table of ESL IDs and associated product IDs, as well as a predetermined table of luminaire IDs and associated luminaire locations. The green and yellow elements respectively refer to an (existing) electronic shelf labelling system and an (existing) coded-light based localization system. The middle elements illustrates a further novel elements of this invention.

More in detail:
At the bottom is depicted, an electronic shelf labelling system, comprising:
   multiple ESLs, each of which has a display and a wireless receiver
   an ESL system controller that has one or more wireless transmitters
   a database which is connected to the ESL system controller that contains a table with ESL IDs and associated product IDs
At the top is depicted, a coded-light based localization system, comprising:
   multiple luminaires, each of which transmitting a unique luminaire ID
   a localization system controller that has a wireless transceiver
   a database which is connected to the localization system controller that contains a table with luminaire IDs and associated luminaire locations.
In the middle is provided, a data combiner system producing a database containing a table of ESL IDs and their estimated location, hence a table of product IDs and their estimated locations.

The bold dotted arrows illustrate the flow of information:

1. At the bottom, a command transmitted or broadcasted (1) by the ESL system controller to one or all ESLs to start displaying their ESL ID as a barcode.
2. In the middle is shown, a capture of an image (2) by the back camera containing the ESL and ESL barcode. The appearance of the ESL is used to estimate its location and orientation relative to the device. The sample barcode in turn is decoded to recover the ESL ID.
3. At the top left is shown, a capture of an image (3) by the front camera containing one or more luminaires from which the luminaire IDs are recovered.
4. In the top middle is shown a wireless transmission (4) from the localization system controller to the device containing the luminaire locations associated with the IDs. The received luminaire locations and their appearance in the camera frame are combined with the device orientation from the embedded motion sensors to estimate the location of the device.
5. In the top middle is shown a wireless transmission (5) from the device to the localization system controller containing the ESL ID and its estimated location.
6. The outcome of this process is a new database containing one or more records including the ESL ID and location. And optionally the product ID, optionally as this is already included in the bottom database. However it will be clear to those skilled in the art that all databases could be combined if so required.

Upon wireless reception, the detected ESL ID, together with its estimated location, is transferred to a data combiner which finds the product ID associated with the detected ESL ID. The product ID, the associated ESL ID and the estimated location are added to a database.

FIG. 3 is a schematic depiction of label location estimation relative to the mobile device camera and simultaneous device location estimation relative to the lighting system. In the same preferred embodiment, the process of estimation of the location of the ESL relative to the camera is also illustrated in FIG. 3.

FIG. 3 described in more in detail:

1. Each luminaire in the shop has a known 3D location and orientation in the shop. The associated mathematical relation follows from the translation and rotation of the luminaire coordinate system with respect to the shop coordinate system.
2. The mathematical relations of the front and back camera with respect to a mobile coordinate system are known.
3. The mobile device recovers its own 3D location and orientation with respect to the luminaire coordinate system on the basis of the luminaire's appearance in the camera frame of the front camera. The associated mathematical relation generally follows from the perspective transformation between the luminaire coordinate system to the sensor plane of the camera in the mobile device in the device coordinate system. Using this relationship in combination with the known 3D location and orientation of the luminaire in the shop, the 3D location and orientation of the device with respect to the shop coordinate system can be recovered.
4. The 3D location of the electronic shelf label with respect to the device follows from the appearance of the label in the camera frame of the back camera. The associated mathematical relation follows from the perspective transformation between the label specific identity pattern in the display plane of the label and in the sensor plane of the device's back camera. The display plane with respect to a label coordinate system is known.
5. Given the recovered 3D location and orientation of the label with respect to the mobile device, and the recovered 3D location and orientation of the mobile device within the shop, the 3D location and orientation of the label within the shop is known and can be collected in a database.

Preferably, the functions of the localization system controller, of the ESL system controller and of data combiner in FIG. 2 are integrated into one single system.

Preferably, the ESL specific alphanumeric identifier or identity pattern is that of the associated product, i.e. the product ID (and not of the ESL ID). This can for instance be the product barcode.

Preferably, the composition of a database containing a table of ESL IDs and associated product IDs is performed by locally scanning the product barcode (from the product package) and associated ESL ID barcode (from the ESL display) during which the coded light is used to estimate the associated location. This results in a combined triplet formed by the ESL ID, the product ID and the location, yet, in one single action.

Notably here substantially at the same time refers to the acquisitions having an overlap in time; such that it is apparent from the registration that the mobile commissioning device was present at the location when the ESL ID was registered and the location was determined.

Preferably, the abovementioned communication of the ESL ID to the smartphone takes place by visible light communication between ESL and smartphone, this requires the ESL to emit modulated light, more preferably the modulated light is modulated using the same modulation technique as used for the modulating the illumination light.

Preferably, the abovementioned communication of the ESL ID to the smartphone combines any form of wireless communication (radio, VLC, IR) with camera capture for precise localization of the ESL with respect to the camera.

Preferably, both the coded light from the lighting system is measured simultaneously with the capture of the ESL ID by the same camera. Using one camera, wherein the coded light from the lighting system is detected from the reflection in the label, limiting the accuracy of the device localization.

Preferably, upon presenting the ESL ID, each label also displays visual markers that facilitate the camera-based estimation of the location and orientation of the ESL with respect to the camera.

Preferably, the ESL ID representation could be in the form an identity pattern such as a QR-Code or ARTag, both of which combine the function as a data carrier and as a spatial fiducial marker for camera-based position- and orientation-estimation.

Preferably, where wireless communication is used, this can be any form of wireless transmission such as, but not limited to, radio communication, visible light communication, infrared light communication, or ultrasonic communication.

Preferably, the communication between ESL system controller and ESLs is performed by the same coded-light enabled lighting system that is used for ESL localization. This means that the luminaires, instead of transmitting a static luminaire-specific ID, transmit the product description and price updates as a digital (locally) broadcasted message embedded in the coded light.

This means that each ESL has a means to receive coded light as well as a second communication means as a return channel, e.g. to communicate a confirmation back to the ESL system controller. This second communication means can be on the basis of radio, visible light communication, IR or any other form of wireless communication.

Preferably, the camera capture of the ESL and camera capture of the lighting system are performed as independent actions. E.g. first, in proximity of the ESL, the device is held in an optimal position to estimate the device location using the lighting system, second, the device is moved towards the ESL to capture the ESL data. The embedded motion sensors can be used to calculate the spatial trajectory between light capture position and ESL capture position such that the ESL position can still be estimated within the shop coordinate system.

Clearly, the order of the two consecutive captures can be reversed, provided that they similarly take place in close proximity.

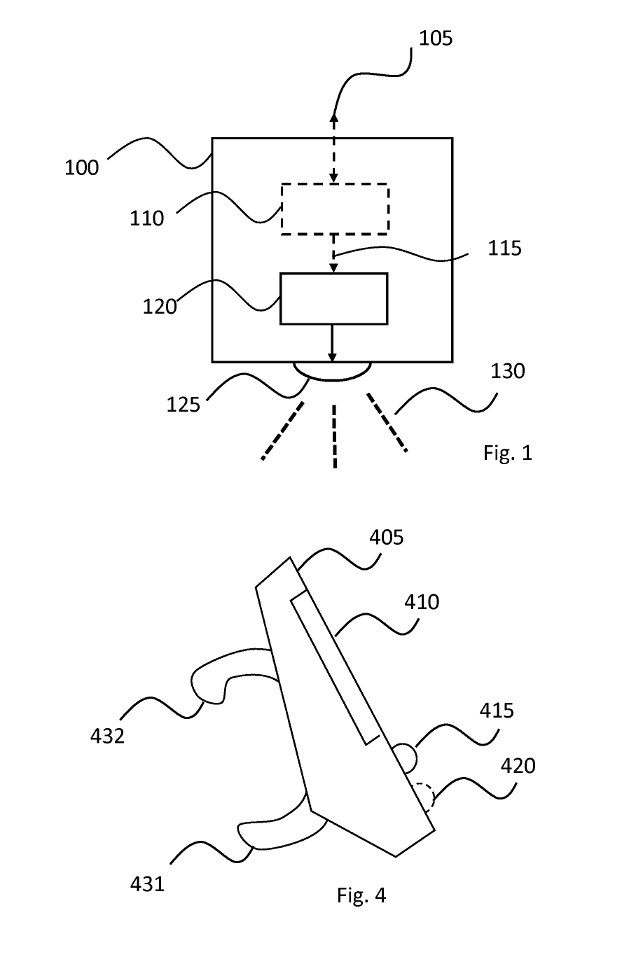

FIG. 1 shows a block diagram of a luminaire for use in the localization system of the claimed invention. The luminaire comprises a driver/modulator arranged to drive the light source comprised in the luminaire; the driver/modulator to this end has to realize a n light output that to the human eye corresponds with the desired illumination lighting, but that in addition thereto also comprises a modulated light component which in combination with the illumination light is substantially invisible to the human eye.

Dependent on the implementation the luminaire may further comprise a data receiver, that may communicate in a wired (e.g. PoE) or wireless (e.g. RF/PLC) manner with the indoor positioning system. Alternatively if the illumination lighting is also used to provide product information to the ESLs, the data provided over the network interface may comprise product information for transmission to the ESLs.

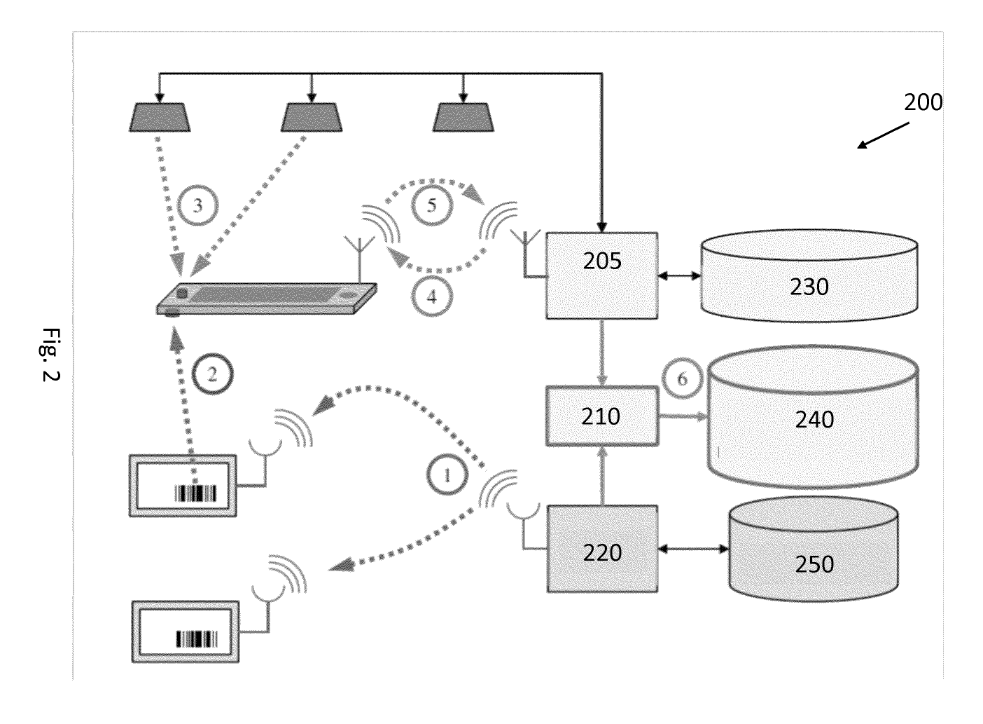

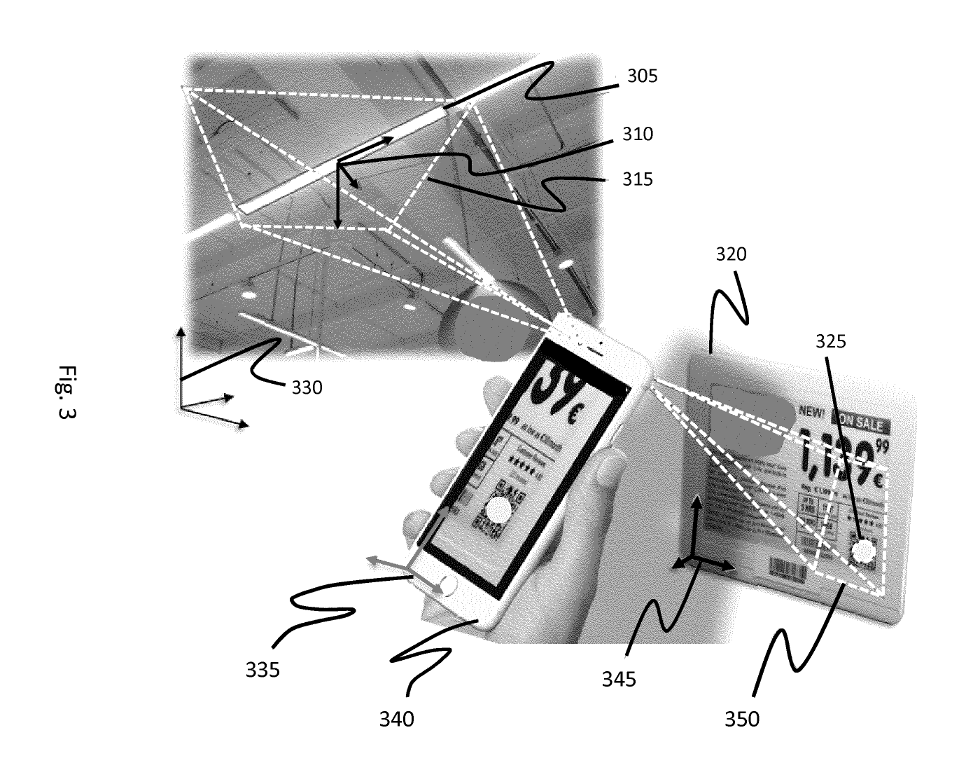

FIG. 4 shows a side view of an ESL comprising clamping members 1 and 2 for removably clamping the ESL housing onto a shelf. The ESL housing further comprises the ESL display for displaying information to end users.

The ESL in FIG. 4 comprises an optical output element in the form of a diffuser that is flush with, or preferably protruding, from the ESL housing that is used to output modulated light from an LED light source. The modulated light preferably includes the ESL ID and is preferably modulated in like manner to the illumination lighting.

Optionally the ESL in FIG. 4 may comprise and optical input element, either flush with the ESL housing or protruding outside the ESL housing for receiving coded light from the coded light communication infrastructure. The latter may be used for communicating product information from luminaires in the vicinity of an ESL location.

More alternatively the ESL may comprise a backlit display, wherein the backlight is modulated and/or in case of a transflective or reflective display the display contents may be modulated.

It will be appreciated that, for clarity, the above description has described embodiments of the invention with reference to different functional units and processors. However, it will be apparent that any suitable distribution of functionality between different functional units or processors may be used without deviating from the invention. For example, functionality illustrated to be performed by separate units, processors or controllers may be performed by the same processor or controllers. Hence, references to specific functional units are only to be seen as references to suitable means for providing the described functionality rather than indicative of a strict logical or physical structure or organization. The invention can be implemented in any suitable form including hardware, software, firmware or any combination of these.

It is noted that in this document the word ‘comprising’ does not exclude the presence of elements or steps other than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and the invention lies in each and every novel feature or combination of features described above or recited in mutually different dependent claims.

1. System for commissioning an electronic shelf label position using a commissioning device, the system comprising the commissioning device and a system back-end, the commissioning device comprising:
a first camera for acquiring images relative to the commissioning device,
a display for providing visual feedback to a commissioner,
a wireless transmitter for transmitting an electronic shelf label identifier and position information from the commissioning device to a processor,
a processing device arranged to process the images,
wherein the commissioning device is arranged to:
acquire a first set of images comprising an electronic shelf label and
extract an electronic shelf label identifier from the first set of images and a relative position of the electronic shelf label relative to the commissioning device,
acquire a second set of images comprising a luminaire emitting coded light,
extract a relative position of the luminaire relative to the commissioning device from the second set of images,
transmit the electronic shelf label identifier and the position information to the system back-end, the position information based on:
the relative position of the electronic shelf label relative to the commissioning device and
the relative position of the luminaire relative to the commissioning device in order to enable the association of the electronic shelf label identifier with the position of the electronic shelf label,
the system back-end comprising
a wireless receiver for receiving the electronic shelf label identifier and the position information and
a processing and storage device for associating the electronic shelf label identifier and the position information and storing this association.

2. The system of claim 1, wherein the position information comprises the electronic shelf label position.

3. The system of claim 1, wherein the electronic shelf label position comprises a longitude and latitude of the electronic shelf label.

4. The system of claim 1, wherein the first set of images and the second set of images are acquired consecutively by the first camera by either:
first acquiring the first images and then acquiring the second images or
first acquiring the second images and then acquiring the first images.

5. The system of claim 4, wherein the commissioning device further comprises:
motion tracking devices comprising a gyroscope, an accelerometer and optionally a magnetometer or alternatively and/or in combination image based motion tracking and wherein the position information is further based on the output of the motion tracking devices over the period in between the acquisition of the first set of images and the second set of images.

6. The system of claim 1, wherein the first set of images and the second set of images are acquired during an overlapping time window.

7. The system of claim 6, wherein the commissioning device comprises a second camera; the first and second camera directed in opposing directions, and wherein the first camera acquires the first set of images and the second camera acquires the second set of images.

8. The method of claim 1 wherein the electronic shelf label identifier is extracted from at least one of:
image information corresponding to a spatially modulated pattern in the first set of images and
image information corresponding to a temporally modulated pattern in the second set of images.

9. Commissioning device for use in commissioning an electronic shelf label position, the commissioning device comprising:
a first camera for acquiring images relative to the commissioning device,
a display for providing visual feedback to a commissioner,
a wireless transmitter for transmitting an electronic shelf label identifier and position information from the commissioning device to a system back-end, and
a processing device arranged to process the images wherein the commissioning device is arranged to:
acquire a first set of images comprising an electronic shelf label and
extract an electronic shelf label identifier from the first set of images and a relative position of the electronic shelf label relative to the commissioning device,
acquire a second set of images comprising a luminaire emitting coded light,
extract a relative position of the luminaire (100) relative to the commissioning device from the second set of images,
transmit the electronic shelf label identifier and the position information to the system back-end, the position information based on:
the relative position of the electronic shelf label relative to the commissioning device and
the relative position of the luminaire relative to the commissioning device in order to enable the association of the electronic shelf label identifier with the position of the electronic shelf label.

10. Method for commissioning an electronic shelf label position using a commissioning device and a system backend, wherein the method comprises:
the commissioning device acquiring a first set of images comprising an electronic shelf label,
the commissioning device extracting an electronic shelf label identifier from the first set of images and a relative position of the electronic shelf label relative to the commissioning device,
the commissioning device acquiring a second set of images comprising a luminaire emitting coded light,
the commissioning device extracting a relative position of the luminaire relative to the commissioning device from the second set of images,
the commissioning device transmitting the electronic shelf label identifier and the position info ration to the system back-end, the position information based on:
the relative position of the electronic shelf label relative to the commissioning device and
the relative position of the luminaire relative to the commissioning device,
receiving the electronic shelf label identifier and the position information by the system back-end and
storing the association of the electronic shelf label identifier and the position information.

11. The method of claim 10, wherein the position information comprises the electronic shelf label position.

12. Method for commissioning an electronic shelf label position using a commissioning device, wherein the method comprises:
the commissioning device acquiring a first set of images comprising an electronic shelf label,
the commissioning device extracting an electronic shelf label identifier from the first set of images and a relative position of the electronic shelf label relative to the commissioning device,
the commissioning device acquiring a second set of images comprising a luminaire emitting coded light,
the commissioning device extracting a relative position of the luminaire relative to the commissioning device from the second set of images,
the commissioning device transmitting the electronic shelf label identifier and the position information to a system back-end, the position information based on:
the relative position of the electronic shelf label relative to the commissioning device and
the relative position of the luminaire relative to the commissioning device.

13. The method of claim 12, wherein the position information comprises the electronic shelf label position.

14. Computer program product downloadable from a communication network and/or stored on a computer readable and/or executable medium, characterized in that it comprises program code instructions for implementing a method according to claim 12.
